(19) United States
(12) Patent Application Publication
(10) Pub. No.: US 2017/0116390 A1
(43) Pub. Date: Apr. 27, 2017

(54) PREDICTION OF ADVERSE DRUG EVENTS

(71) Applicant: INTERNATIONAL BUSINESS MACHINES CORPORATION, ARMONK, NY (US)

(72) Inventors: Achille B. Fokoue-Nkoutche, White Plains, NY (US); Oktie Hassanzadeh, Port Chester, NY (US); Mohammad Sadoghi Hamedani, Chappaqua, NY (US); Meinolf Sellmann, Cortlandt Manor, NY (US); Ping Zhang, White Plains, NY (US)

(21) Appl. No.: 14/953,590

(22) Filed: Nov. 30, 2015

Related U.S. Application Data
(63) Continuation of application No. 14/920,327, filed on Oct. 22, 2015.

(51) Int. Cl. G06F 19/00

(52) U.S. Cl. CPC G06F 19/3456; G06F 19/326

(57) ABSTRACT

Embodiments include method, systems and computer program products for predicting adverse drug events on a computational system. Aspects include receiving known drug data from drug databases and one or more of a candidate drug, a drug pair, and a candidate drug-patient pair. Aspects also include calculating an adverse event prediction rating representing a confidence level of an adverse drug event for the candidate drug, a drug pair, and a candidate drug-patient pair, the rating being based on the known drug data. Aspects also include associating adverse event features with the candidate drug, drug pair, or a candidate drug-patient pair, including a nature, cause, mechanism, or severity of the adverse drug event. Aspects also include calculating and outputting an adverse event prediction rating.

### PRIORITY

This application is a Continuation of U.S. patent application Ser. No. 14/920,327, filed Oct. 22, 2015, and all the benefits accruing therefrom under 35 U.S.C. §119, the contents of which in its entirety are herein incorporated by reference.

### BACKGROUND

The present disclosure relates to prediction of adverse drug events and more specifically, to methods, systems and computer program products for analysis of data to provide personalized and detailed adverse drug events.

Adverse drug events pose several challenges to the healthcare system. Over 2 million serious adverse drug events occur yearly and as many as 100,000 related deaths may occur each year as a result. Adverse drug events are a leading cause of death ahead of pulmonary disease, diabetes, AIDS, accidents and automobile deaths and are believed to be responsible for as many as one in five injuries or deaths in hospitalized patients. Moreover, the yearly cost associated with adverse drug events is estimated at $136 billion dollars, which is higher than costs associated with diabetic and cardiovascular care. Drug-drug interactions, for example, may account for up to 5% of in-hospital medication errors. As the number of approved drugs increases, the number of potential adverse events also increases. In some cases, adverse events are not revealed in clinical trials, which typically rely upon a patient set of only about 1,500 patients. This sample size is potentially insufficient to elucidate rare toxicity profiles of some drugs, which may occur in a lesser incidence yet, due to the nature of the event, remain a significant health risk. For instance, as many as one out of every 20,000 patients experienced liver toxicity associated with ingestion of bromfenac, a drug formerly approved and marketed for short-term pain relief. Moreover, clinical trials might not reveal a number of potential drug-drug interactions if the patients studied do not take the secondary drug, or take the secondary drug but on a scale such that a statistically significant correlation might not be seen.

Public databases contain a variety of information regarding known drugs, including chemical structural data and chemical data. These information sources may contain structured or unstructured data. For, scientific literature may report results or observations related to known drugs in either a non-clinical or a clinical setting in a narrative document. For example, a physician may report an observation of an individual adverse event experience by a patient, or a chemist may surmise that a given drug operates by a particular mechanism given its chemical structure. However, the compilation and analysis of such data has remained complicated by the lack of structure in such reporting. Moreover, many databases contain incomplete data for a given drug, and it thus can be difficult to computationally distinguish between a missing datum, for example when it is not known if a drug in question contains a particular feature, and a negative event, such as when a drug is known not to have that particular feature. In addition, such public sources generally lack personalized information, such as demographic or genomic information, that might reveal potential adverse events for candidate drugs or for individual candidate patients.

### SUMMARY

In accordance with an embodiment, a method for predicting adverse drug events is provided. The method includes receiving known drug data from one or more drug databases and one or more of a candidate drug, a drug pair, and a candidate drug-patient pair. The method also includes calculating an adverse event prediction rating, the adverse event predicting rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair. The method also includes calculating an adverse event prediction rating, the adverse event prediction rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair. The method also includes associating one or more adverse event features with the one or more of a candidate drug, a drug pair, and a candidate drug-patient pair, including one or more of a nature, a cause, a mechanism, or a severity of the adverse drug event. The method also includes calculating an adverse event prediction rating based on the one or more adverse event features and outputting the adverse event prediction rating.

In accordance with another embodiment, a processing system for predicting adverse drug events includes a processor in communication with one or more types of memory. The processor is configured to receive known drug data from one or more drug databases and one or more of a candidate drug, a drug pair, and a candidate drug-patient pair. The processor is also configured to calculate an adverse event prediction rating, the adverse event predicting rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair. The processor is also configured to calculate an adverse event prediction rating, the adverse event prediction rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair. The processor is also configured to associate one or more adverse event features with the one or more of a candidate drug, a drug pair, and a candidate drug-patient pair, including one or more of a nature, a cause, a mechanism, or a severity of the adverse drug event. The processor is also configured to calculate an adverse event prediction rating based on the one or more adverse event features and outputting the adverse event prediction rating.

In accordance with a further embodiment, a computer program product for predicting adverse drug events includes a non-transitory storage medium readable by a processing circuit and storing instructions for execution by the processing circuit for performing a method. The method includes receiving known drug data from one or more drug databases and one or more of a candidate drug, a drug pair, and a candidate drug-patient pair. The method also includes calculating an adverse event prediction rating, the adverse event predicting rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair. The method also includes calculating an adverse event prediction rating, the adverse event prediction rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair. The method also includes associating one or more adverse event features with the one or more of a candidate drug, a drug pair, and a candidate drug-patient pair, including one or more of a nature, a cause, a mechanism, or a severity of the adverse drug event. The method also includes calculating an adverse event prediction rating based on the one or more adverse event features and outputting the adverse event prediction rating.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates a cloud computing environment capable of supporting core logic included in a mobile device data allocation system according to a non-limiting embodiment;

FIG. 2 is a schematic diagram of a cloud computing node included in a distributed cloud environment;

FIG. 3 is a set of functional abstraction layers provided by a cloud computing environment capable of supporting core logic included in a mobile device data allocation system according to a non-limiting embodiment;

FIG. 4 is a schematic diagram illustrating a user interface of an application providing adverse event features for a candidate drug or drug pair or drug-patient pair in accordance with an exemplary embodiment;

FIG. 5 is a flow diagram of a method for predicting adverse drug reactions in accordance with an exemplary embodiment;

FIG. 6 is a flow diagram of another method for predicting adverse drug reactions in accordance with an exemplary embodiment;

FIG. 7 is a flow diagram of a method for discounting popular terms in a method for predicting adverse drug reactions in accordance with an exemplary embodiment; and

FIG. 8 is a flow diagram of a further method for predicting adverse drug reactions in accordance with an exemplary embodiment.

### DETAILED DESCRIPTION

In accordance with exemplary embodiments of the disclosure, methods, systems and computer program products for predicting adverse drug reactions are provided. In exemplary embodiments, known drug data can be obtained from a variety of databases and a prediction can be made regarding the presence or absence of an adverse event for a candidate drug or drug-pair based on the known drug data and an adverse prediction rating, representing a confidence level for the prediction, can be calculated. In exemplary embodiments, a prediction can be made regarding the features of the adverse event, such as the nature of the adverse event, the cause of the event, the mechanism of the event, and/or the severity of the event, based on the known drug data. In exemplary embodiments, patient health record data for a multitude of patients can be obtained and a prediction can be made regarding the presence or absence of an adverse event for a candidate drug-patient pair based on known drug data and the multitude of patient health record data and an adverse prediction rating, representing a confidence level for the prediction, can be calculated. In exemplary embodiments, adverse event features can be personalized to a patient.

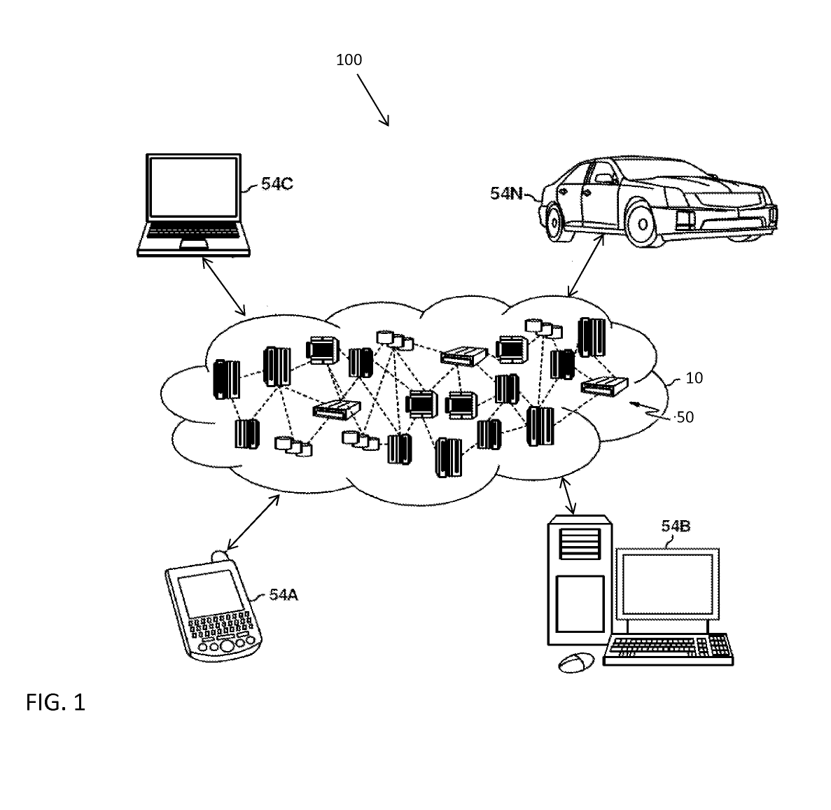

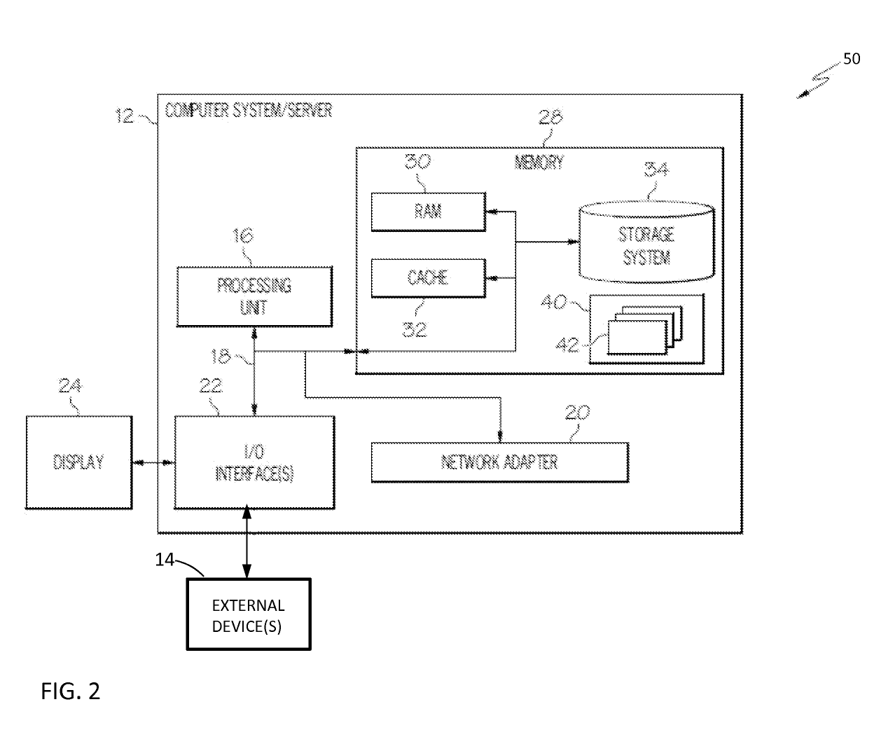

With reference now to FIG. 1, a cloud computing environment 10 capable of supporting the teachings herein is illustrated according to a non-limiting embodiment. As shown, cloud computing environment 10 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. The nodes 50 may communicate with one another. They may be grouped (not shown) physically or virtually, in one or more networks, such as Private, Community, Public, or Hybrid clouds as described hereinabove, or a combination thereof. This allows cloud computing environment 10 to offer infrastructure, platforms and/or software as services for which a cloud consumer does not need to maintain resources on a local computing device. It is understood that the types of computing devices 54A-N shown in FIG. 2 are intended to be illustrative only and that computing nodes 50 and cloud computing environment 10 can communicate with any type of computerized device over any type of network and/or network addressable connection (e.g., using a web browser).

Referring now to FIG. 2, a schematic of a cloud computing node 50 included in a distributed cloud environment or cloud service network is shown according to a non-limiting embodiment. The cloud computing node 50 is only one example of a suitable cloud computing node and is not intended to suggest any limitation as to the scope of use or functionality of embodiments of the invention described herein. Regardless, cloud computing node 50 is capable of being implemented and/or performing any of the functionality set forth hereinabove.

In cloud computing node 50 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 2, computer system/server 12 in cloud computing node 50 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

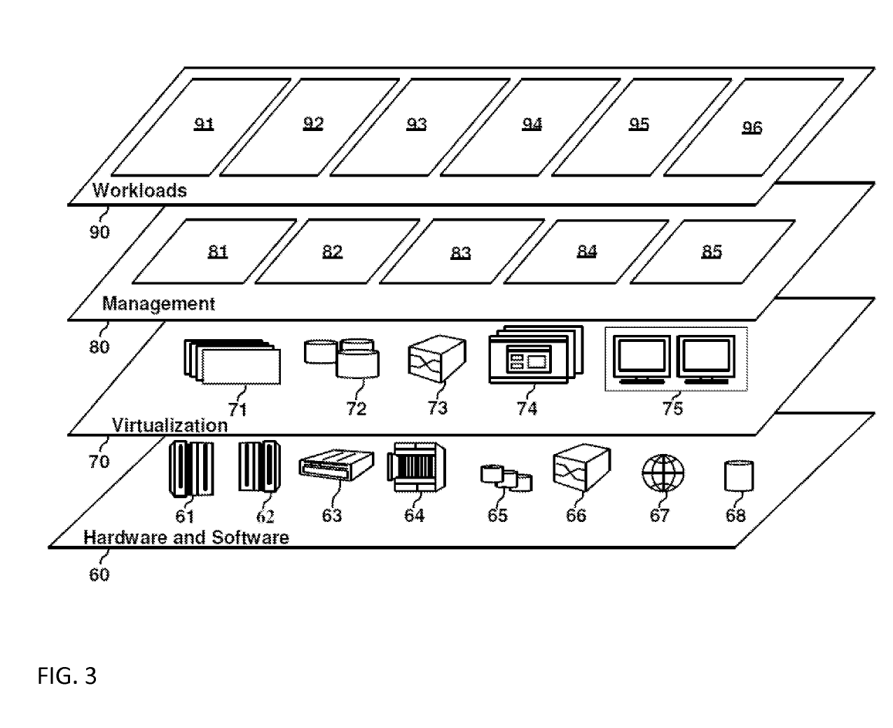

Referring now to FIG. 3, a set of functional abstraction layers provided by cloud computing environment 10 is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provided pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

Although a cloud environment capable of supporting the core logic of the data service network system 102 is described in detail above, it should be appreciated that the core logic of the data service network system 102 can reside locally on one or more of the devices 54A-54N. For instance, each mobile device 54A may have installed locally thereon the core logic of the data service network system 102. In this manner, the mobile devices 54 can perform locally the various features and operations of the data service network system 102.

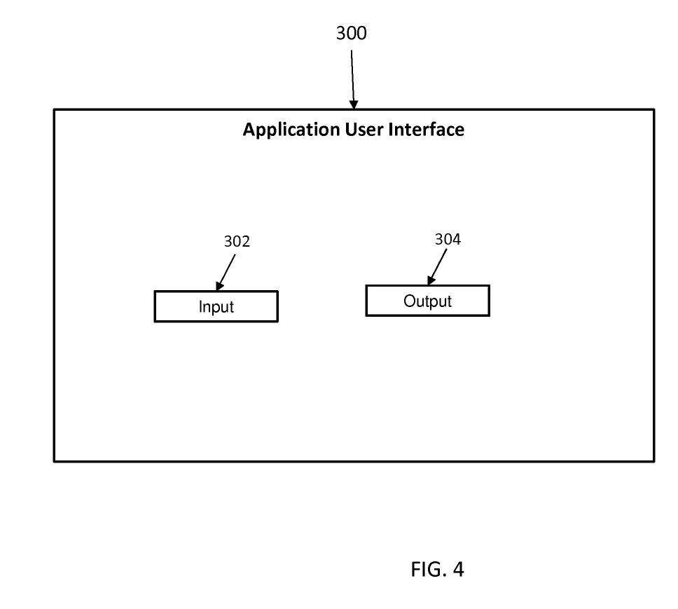

Referring now to FIG. 4, a schematic of an application user interface 300 of an application in accordance with an exemplary embodiment is illustrated. As illustrated the application user interface 300 includes an input 302 and an output 304. In exemplary embodiments, the input may include an object that may be an image, hyperlink or other item that is associated with a functional object, as discussed above. For example, the object may be a search button that is located next to a textual input filed on a website. In another example, the object may be a hyperlink that directs a web browser to another website.

In exemplary embodiments, the user may provide a candidate drug or candidate patient at input 302 on an application user interface. In one embodiment, the input 302 may be configured to allow free form input, i.e., unstructured textual input from the user. In another embodiment, the input 302 may present the user with a window containing one or more multiple choice questions that allow the user to select from a series of drug candidates or patient candidates.

In exemplary embodiments, an adverse event prediction rating is provided to a user interface at output 304. In some embodiments, the adverse event prediction rating is provided with an associated adverse event feature. In exemplary embodiments, output 304 may simultaneously or sequentially provide several adverse prediction ratings and adverse event features. In exemplary embodiments, output 304 may present the user with all available adverse event features and an adverse prediction rating for a candidate drug, drug-drug pair, or drug-patient pair for each feature.

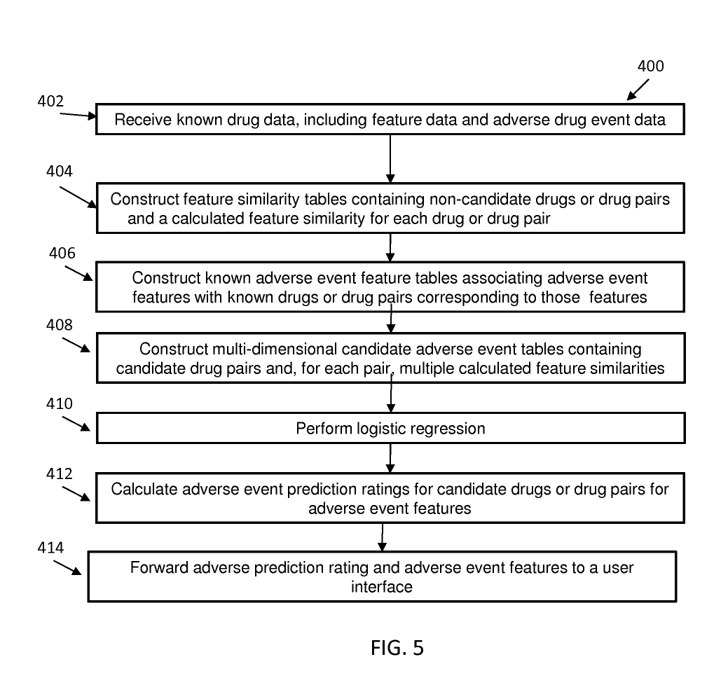

Referring now to FIG. 5, a flow diagram of a method 400 for predicting adverse drug reactions in accordance with an exemplary embodiment is shown. As shown at block 402, the method 400 includes receiving known drug data, including feature data and adverse drug event data. Next as shown at block 404, the method 400 includes constructing one or more feature similarity tables containing non-candidate drugs or drug pairs and a calculated feature similarity for each drug or drug pair. The method 400 also includes constructing known adverse event feature tables, as shown at block 406. In exemplary embodiments, the adverse event feature tables associate adverse event features with known drugs or drug pairs corresponding to those features. The method 400 also includes constructing multi-dimensional candidate adverse event tables. In exemplary embodiments, the candidate adverse event tables contain candidate drug pairs and, for each pair, multiple calculated feature similarities. Next, as shown at block 410, the method 400 includes performing a logistic regression. The method 400, as shown at block 412, also includes calculating adverse event prediction ratings for candidate drugs or drug pairs for one or more adverse event features. Next, as shown at block, 414, the method 400 includes forwarding the adverse prediction rating and the adverse event features to a user interface.

Known drug data can include structured data, unstructured data, or both structured and unstructured data. As used herein, structured data includes data that is categorized or grouped in accordance with a system of defined rules. As used herein, unstructured data includes data that is not categorized or grouped in accordance with a system of defined rules. For example, unstructured data includes, but is not limited to, data published in journal articles in a narrative format. In exemplary embodiments, known drug data includes data from databases generally known to persons of ordinary skill in the art. For example, known drug data can include data from the DrugBank database, UniProt, Unified Medical Language System TM, PubMed, and/or various scientific journals, including, but not limited to, the Journal of Clinical Oncology, JAMA, BJC, and Clinical Infectious Diseases.

Known drug data can include any information associated with a drug. In exemplary embodiments, known drug data includes feature data and adverse drug event data. For example, known drug feature data includes, but is not limited to, structural data, including for example chemical formula, stereochemistry, chemical structure, crystal structure, primary, secondary, or tertiary protein or peptide structure, nucleotide sequence or confirmation; mechanistic data, including for example mechanism of action; drug metabolism information, including metabolizing enzymes, metabolism pathway; drug physiological effect; drug target; anatomical therapeutical chemical classification; DrugBank category; Chemical-Protein Interactome (CPI) profile. Adverse drug event data includes information related to adverse events associated with a drug. Adverse drug event data can include, for example, the incidence, prevalence, or severity of events such as bleeding, paralysis, and hyperkalemia.

In exemplary embodiments, predictions of adverse events can be made regarding adverse events concerning a candidate drug. For example, predictions can be made concerning the adverse event features predicted to be associated with a candidate drug. In other embodiments, predictions can be made regarding adverse events concerning a candidate drug-drug pair. For example, predictions can be made concerning the adverse event features predicted to be associated when a patient is administered a certain pair of drugs. In other embodiments, predictions can be made regarding adverse events concerning a candidate patient-drug pair. As used herein, candidate patient-drug pair means a candidate drug that is to be administered to a patient with a particular characteristic or medical history. In some embodiments, predictions can be personalized to a particular patient.

In some embodiments, one or more feature similarity tables can be constructed. In exemplary embodiments, a feature similarity table includes non-candidate drugs or drug pairs and a calculated feature similarity for each drug or drug pair. For example, in some embodiments, a feature similarity table can identify, a similarity based upon a numerical scale from 0 to 1 (Sim), where 0 is not similar, and 1 is very highly similar, between multiple pairs of drugs. For example, a number (N) of feature similarity tables could be related to one of several features numbered 1-N, where N represents a given known feature, such as chemical structure, and may include three columns as follows:

| | | |
|---|---|---|
| Drug 1 | Drug 2 | Sim |

Sim1 (Chemical Structure)

| | | |
|---|---|---|
| Salsalate | Aspirin | 0.9 |
| Dicoumarol | Warfarin | 0.76 |

. . .
SimN

| | | |
|---|---|---|
| Salsalate | Aspirin | 0.7 |
| Dicoumarol | Warfarin | 0.6 |

Similarities can be calculated by any metrics. For example, but not by way of limitation, the calculated similarity can be determined by assessing Cosine similarity, Jaccard/Tanimoto similarity, Pearson correlation, chemical structure similarity metrics, or CPI-based similarity metrics.

In exemplary embodiments, multiple known adverse event feature tables can be constructed. A known adverse event feature table can associate adverse event features with known drugs or drug pairs corresponding to those features. For example, a known adverse event feature table can provide a listing of all drug pairs associated with a particular adverse event, such as headache. In exemplary embodiments, a number (M) of known adverse event feature tables for adverse events of type 1 to M can be provided as dual column tables as follows:

| | |
|---|---|
| Drug 1 | Drug 2 |

Known Drug Interactions of Type 1

| | |
|---|---|
| Aspirin | Gliclazide |
| Aspirin | Dicoumarol |

. . .
Known Drug Interactions of Type M

| | |
|---|---|
| Aspirin | Probenicid |
| Aspirin | Azilsartan |

In exemplary embodiments, multi-dimensional candidate adverse event tables can be constructed based upon the feature similarity tables and the adverse event feature tables. In some embodiments, the multi-dimensional candidate adverse event tables include multiple drug similarity measures from multiple structured and unstructured data sources to compare drugs. Drugs can be compared based upon any known feature. Exemplary comparative features that can be used to compare drugs include, but are not limited to, drug metabolizing enzyme based similarities, drug mechanism of action based similarities, drug physiological effect based similarities, CPI profiles based similarity, pathways based similarities, gene-based topology similarities, chemical structure similarity, drug target similarity, anatomical therapueutical chemical classification system based similarity, and DrugBank category. Moreover, for a single known feature, data from multiple sources can be collected and compared. An exemplary candidate adverse event table may be of the following format:

Candidate Adverse Event of Type 1 Features

| | | | | |
|---|---|---|---|---|
| | | Best | | Best |
| Drug 1 | Drug 2 | Sim1*Sim1 | . . . | SimN*SimN |

| | | | |
|---|---|---|---|
| Salsalate | Gliclazide | 0.9*1 | 0.7*1 |
| Salsalate | Warfarin | 0.9*0.76 | 0.7*0.6 |

In exemplary embodiments, a supervised machine learning process (e.g., logistic regression) is performed to determine, from the known adverse event tables, a classifier capable of predicting adverse drug events. Logistic regression can, in some embodiments, correct for rare events. Logistic regression can be performed, for example, using the multi-dimensional candidate adverse event tables and known adverse event tables to create machine learning feature vectors for each candidate.

In some embodiments, additional machine learning features are created to correct for incomplete similarity matrixes. Incomplete similarity matrixes can result, for example, where each one of multiple sources provides data for only a subset of all drugs and drug features considered. For a given candidate with a low similarity based prediction for a drug feature, for example, it can desirable to distinguish between missing information and information that is present but high or low on the similarity scale. For a similarity metric sim, in some embodiments, new calibration features can be defined independently of the set of known adverse drug event data and feature data:
1) For a drug d and the similarity metric sim, a calibration feature FeatureAvg(d, sim) estimates the average (i.e., arithmetic mean) similarity of drug d relative to all other known drugs. It is computed as follows:
   FeatureAvg(d, sim)=Σ×_{εDrugs-{d}}sim(d, X)/(|Drugs|−1) where Drugs is the set of all drugs and |Drugs| is the total number of drugs.
2) For a drug d and the similarity metric sim, a calibration feature FeatureStd(d, sim) estimates the standard deviation of a random variable Y=sim(d, X), where X is a drug different from d (i.e., XεDrugs−{d}).

In exemplary embodiments, the method includes weighting the feature similarities to account for relatively rare or relatively common features. In some embodiments, features similarities are weighted to discount popular features. In exemplary embodiments, popular features can be discounted by using Inverse Document Frequency (IDF) to assign more weight to relatively rare features according to:

IDF(t,Drugs)=log((|Drugs|+1)/(DF(t,Drugs)+1))

wherein Drugs represents the set of all drugs, t represents a feature, such as mechanism of action or physiological effect, and DF(t, Drugs) represents the number of drugs in Drugs with the feature t. In exemplary embodiments, the weighting is conducted before calculating a feature similarity, such as before calculating a Cosine similarity.

In some embodiments, logistic regression provides an adverse event prediction rating. The adverse event prediction rating represents the confidence level of an adverse drug event for a candidate drug or drug pair or a candidate drug-patient pair. In exemplary embodiments, the adverse event prediction rating is based, at least in part, on known drug data for one or more non-candidate drugs or drug pairs. In exemplary embodiments, the adverse event prediction rating is a value between 0 and 1. In some embodiments, the adverse event prediction rating represents the confidence level that an adverse drug event will occur when a candidate drug is administered to the general population. In some embodiments, the adverse event prediction rating represents the confidence level that an adverse drug event will occur when a candidate drug is administered to a patient defined characteristics or medical history. In some embodiments, the adverse event prediction rating represents the confidence level that an adverse drug event will occur when a candidate drug is administered to a particular patient.

In some embodiments, the adverse event prediction rating represents the confidence level that an adverse drug event will occur when a candidate drug pair is administered to the general population. In some embodiments, the adverse event prediction rating represents the confidence level that an adverse drug event will occur when a candidate drug pair is administered to a patient defined characteristics or medical history. In some embodiments, the adverse event prediction rating represents the confidence level that an adverse drug event will occur when a candidate drug pair is administered to a particular patient.

In some embodiments, adverse event prediction rating and adverse event features for a candidate drug or drug pair or drug-patient pair are forwarded to a user interface. In some embodiments, the adverse event prediction rating and adverse event features for multiple candidate drug or drug pair or drug-patient pairs are forwarded to a user interface.

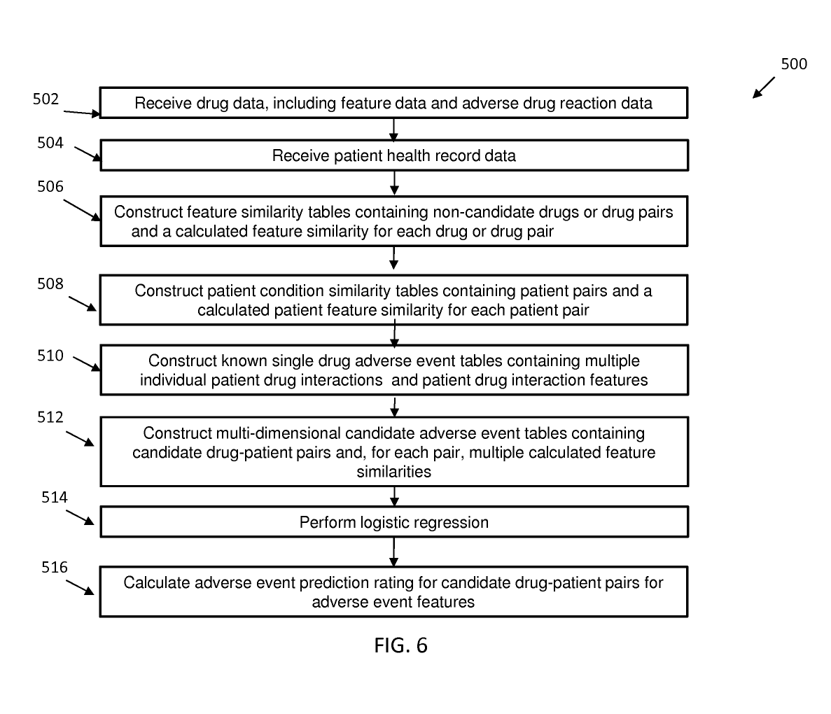

Referring now to FIG. 6, a flow diagram of a method 500 for predicting adverse drug reactions in accordance with an exemplary embodiment is shown. As shown at block 502, the method 500 includes receiving known drug data, including feature data and adverse drug event data. Next as shown at block 504, the method 500 includes receiving patient health record data. Although FIG. 6 depicts receiving drug data prior to receiving patient data, it is understood that in some embodiments, patient health record data may be received prior to or at the same time as receiving drug data. As shown at block 506, the method 500 includes constructing one or more feature similarity tables containing non-candidate drugs or drug pairs and a calculated feature similarity for each drug or drug pair. As shown at block 508, the method 500 includes constructing patient condition similarity tables containing patient pairs and a calculated patient feature similarity for each patient pair. The method 500 also includes, as shown at block 510, constructing known single drug adverse event tables containing multiple individual patient drug interactions and patient-drug interaction features. The method 500 also includes constructing multi-dimensional candidate adverse event tables, as shown at block 512. In exemplary embodiments, the candidate adverse event tables contain candidate drug-patient pairs and, for each pair, multiple calculated feature similarities. Next, as shown at block 514, the method 500 includes performing a logistic regression. The method 500, as shown at block 512, also includes calculating adverse event prediction ratings for candidate drugs or drug pairs for one or more adverse event features.

Patient health record data includes any information related to a patient that might be collected by a medical health professional and included in a record. Such information includes, but is not limited to, demographic data, including age, gender, or ethnicity, current medical conditions, prior medical conditions, current symptoms, prior symptoms, height, weight, genomic data, current and prior medications, or current and prior adverse events.

In some embodiments, a number (M) of patient condition similarity tables are constructed. Patient condition similarity tables can relate to a feature 1-M, and can contain patient pairs and a calculated patient feature similarity for each patient pair. Patient feature similarities can be calculated by any available means and using known similarity metrics, such as Cosine similarity.

In some embodiments, multi-dimensional candidate adverse event tables include candidate drug-patient pairs and, for each pair of patients, multiple calculated feature similarities. For example, a series of individual patients may be compared to one another based upon incidence of headaches in a single candidate adverse event table.

In some embodiments, candidate adverse event tables are based, at least in part, on multi-dimensional patient profiles containing multiple patient similarities comparing patients based upon a number of characteristics or features.

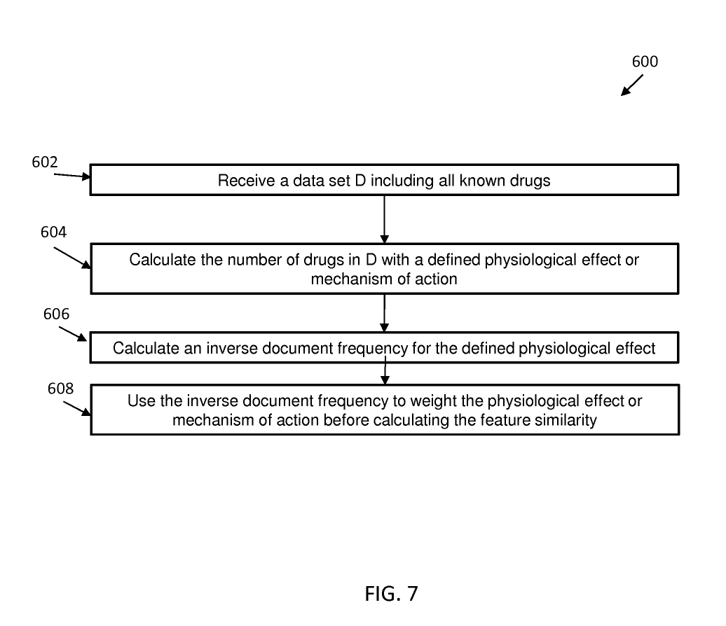

Referring now to FIG. 7, a flow diagram of a method 600 for discounting popular terms in a method for predicting adverse drug reactions on in accordance with an exemplary embodiment is shown. As shown at block 602, the method 600 includes receiving a data set D, including all known drugs. Next, the method 600 includes calculating the number of drugs in D with a defined physiological effect or mechanism of action, as shown in block 604. The method 600 also includes calculating an inverse document frequency for the defined physiological effect, as shown at block 606. Next, as shown at block 608, the method 600 includes using the inverse document frequency to weight the physiological effect or mechanism of action before calculating the feature similarity.

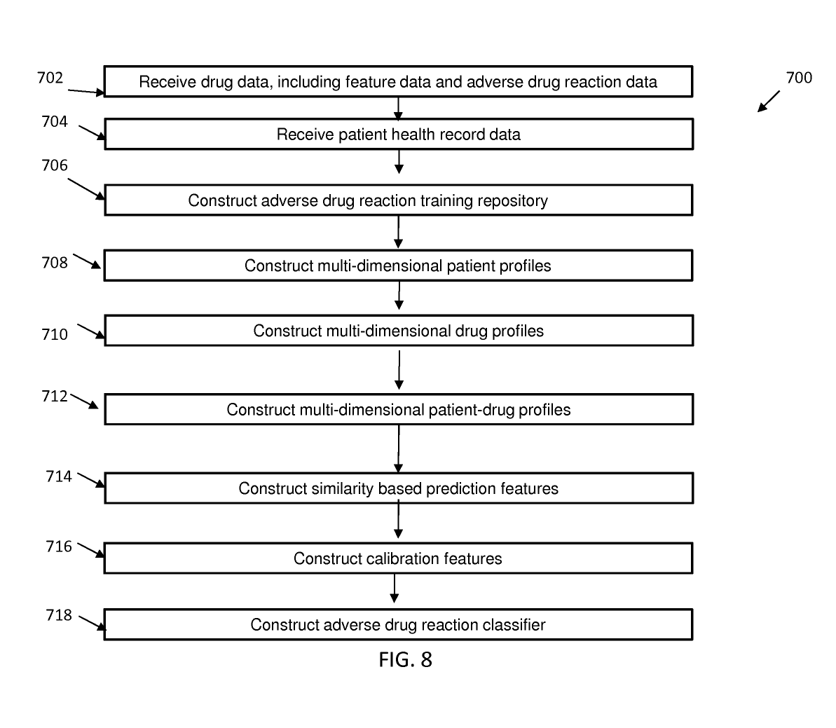

Referring now to FIG. 8, a flow diagram of a method 700 for predicting adverse drug reactions in accordance with an exemplary embodiment is shown. As shown at block 702, the method 700 includes receiving known drug data, including feature data and adverse drug event data. Next as shown at block 704, the method 500 includes receiving patient health record data. As shown at block 706, the method 700 includes constructing an adverse drug reaction training repository. The adverse drug reaction training repository can include, in some embodiments, one or more of the feature similarity tables, known adverse event feature tables, patient condition similarity tables, or known single drug adverse event tables. As shown at block 708, the method 700 includes constructing multi-dimensional patient profiles. Next, as shown at block 710, the method 700 includes constructing multi-dimensional drug-profiles. Multi-dimensional drug profiles can include candidate adverse event tables including features from multiple structured and unstructured data sources. Next, the method 700, as shown at block 712, includes constructing multi-dimensional patient-drug profiles. As shown at block 714, the method 700 includes constructing similarity-based prediction features. As shown at block 716, the method includes constructing calibration features. Next, as shown at block 718, the method 700 includes constructing an adverse drug reaction classifier.

In one example, multi-dimensional patient profiles compare patients from a variety of perspectives. A patient can be represented, for example, by a profile that includes attributes such as age, gender, race, genomic data, current health conditions, and prior conditions. Multiple similarity measures can, for instance, be calculated for a variety of patient features or characteristics.

In exemplary embodiments, multi-dimensional patient-drug profiles can compare m patients and n sets of medications used by m patients by calculating similarity measures that combine information from multi-dimensional drug profiles with multi-dimensional patient profiles. For example, a multi-dimensional patient-drug profile can include a multitude of data sets that include a patient identifier, a drug taken by the patient, and a related adverse event.

In some embodiments, for each data set that includes a patient identifier, a drug taken by the patient, and a related adverse event, a similarity-based prediction feature is calculated, where the similarity based prediction feature corresponds to values in columns of the candidate adverse event tables. A similarity-based prediction feature can be represented by the average of the top K most similar known patient-drug profile in the adverse drug reaction training repository.

In exemplary embodiments, a method includes building an adverse drug event classifier that predicts adverse drug events that a particular patient might experience. In some embodiments, the adverse drug event classifier calculates, based on the adverse drug training repository and based at least in part on target patient characteristics or patient medical record data, an adverse event prediction rating that is personalized to a patient. In some embodiments, the adverse drug event classifier calculates adverse event features that are personalized to a patient. In one embodiment, the adverse drug event classifier provides the nature of an adverse drug event that is personalized to a patient. In one embodiment, the adverse drug event classifier provides the cause of an adverse drug event that is personalized to a patient. In another embodiment, the adverse drug event classifier provides the mechanism of an adverse drug event that is personalized to a patient. In another embodiment, the adverse drug event classifier provides the severity of an adverse drug event that is personalized to a patient.

For example, a physician desiring to treat a particular patient, faced with a number of candidate drugs, may seek to know any likely adverse events prior to choosing which candidate drug to prescribe. The physician may use an adverse drug event training repository to construct multi-dimensional patient-drug profiles and similarity based prediction features to determine which of the candidate drugs to prescribe. For instance, the physician may input the candidate drugs into a user interface and receive, as an output, an indication that several of the candidate drugs are highly likely to result in a serious adverse event. For example, the output may indicate that a first drug is likely to result in coma based upon a chemical similarity to another drug that resulted in coma with a similar set of patients. Thus, the physician can avoid prescribing that first drug in favor of another candidate drug. The output can, for instance, indicate that two candidate drugs are likely to result in headache but, based on the patient's gender, the severity of the headache is likely to differ such that one of the candidate drugs is only likely to result in a mild headache. The output informs the physician of candidates likely to result in an adverse event. The output can also inform the physician of the nature and severity fo the adverse events. The physician can then, after receiving the output, prescribe an optimal drug to the patient.

In another example, a scientist faced with a known drug may seek to determine which of a number of structural analogues to pursue in pre-clinical or clinical trials. The scientist can provide the candidate drug information to the processor. The processor can calculate adverse event prediction ratings for each candidate based on several adverse event features and output the ratings to the scientist. The processor can rank the candidate drugs based on the various features from most favorable to least favorable. The scientist can then pursue pre-clinical or clinical trials with the highest ranked drug.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for predicting adverse drug events, the method comprising:
receiving, by a processor, known drug data from one or more drug databases and one or more of a candidate drug, a drug pair, and a candidate drug-patient pair;
calculating, by the processor, an adverse event prediction rating, the adverse event prediction rating representing a confidence level of an adverse drug event for the one or more of a candidate drug, a drug pair, and a candidate drug-patient pair, the adverse event prediction rating being based on the known drug data corresponding to the one or more of a candidate drug, a drug pair, and a candidate drug-patient pair;
associating, by the processor, one or more adverse event features with the one or more of a candidate drug, a drug pair, and a candidate drug-patient pair, including one or more of a nature, a cause, a mechanism, or a severity of the adverse drug event;
calculating an adverse event prediction rating based on the one or more adverse event features; and
outputting the adverse event prediction rating.

2. The computer-implemented method of claim 1, further comprising calculating one or more feature similarities of the one or more of a candidate drug, a drug pair, and a candidate drug-patient pair and weighting the one or more feature similarities to account for relatively rare or common features.

3. The computer-implemented method of claim 1, wherein the known drug data contains unstructured data.

4. The computer-implemented method of claim 1, comprising constructing one or more multi-dimensional patient profiles including multiple patient similarity measures, wherein the adverse event prediction rating is further based on the multi-dimensional patient profiles.

5. The computer-implemented method of claim 1, comprising constructing one or more multi-dimensional drug profiles including multiple adverse event features for the one or more of a candidate drug, a drug pair, and a candidate drug-patient pair, wherein the adverse event prediction rating is further based on the multi-dimensional drug profiles.

6. The computer-implemented method of claim 1, comprising constructing multi-dimensional patient profiles, constructing multi-dimensional patient-drug files, and calibrating patient data in one or more of the multi-dimensional patient profiles or the multi-dimensional patient-drug files.

7. The computer-implemented method of claim 1, wherein the adverse event prediction rating and the adverse event features are further based on a patient health data record and are personalized to a patient.
